(19) United States
(12) Patent Application Publication
(10) Pub. No.: US 2026/0175446 A1
(43) Pub. Date: Jun. 25, 2026

(54) ROBOTIC ARM GRIPPER WITH TWO-PART FINGER MEMBERS

(71) Applicant: Dubai Future Foundation, Dubai (AE)

(72) Inventors: Rajkumar Muthusamy, Dubai (AE); Tanzim Ahmed, Dubai (AE); Tarek Taha, Dubai (AE); Khalifa AlQama, Dubai (AE)

(73) Assignee: Dubai Future Foundation, Dubai (AE)

(21) Appl. No.: 19/426,485

(22) Filed: Dec. 19, 2025

Related U.S. Application Data
(60) Provisional application No. 63/737,091, filed on Dec. 20, 2024.

(51) Int. Cl. B25J 15/00; B25J 9/16; B25J 15/08

(52) U.S. Cl. CPC B25J 15/0028; B25J 9/1697; B25J 15/08

(57) ABSTRACT

A robotic arm gripper includes a base unit, a finger module movably disposed on the base unit, and a multi-camera vision system disposed on the base unit. The multi-camera vision system can include a first camera and a second camera disposed at opposite sides of the base unit for observing object features, finger positions, and workspace dynamics. The finger module includes two two-part finger members, each of which includes an inner unit and an outer unit.

### CROSS-REFERENCE TO RELATED APPLICATIONS

The present application claims priority to U.S. Provisional Patent Application No. 63/737,091, titled “ROBOTIC ARM GRIPPER WITH TWO-PART FINGER MEMBERS” and filed on December 20, 2024, the entire contents of which is hereby incorporated by reference herein for all purposes.

### TECHNICAL FIELD

The present disclosure relates to a robotic arm gripper and in particular to a robotic arm gripper with two-part finger members.

### BACKGROUND

Robotic grippers face some limitations that hinder their effectiveness in complex and dynamic environments. They sometimes struggle to adapt to objects of varying shapes, sizes, and fragility, making them unsuitable for handling delicate or irregularly shaped items. The lack of compliance in these systems increases the risk of damaging objects during grasping or in the event of accidental collisions. Furthermore, some grippers have limited capabilities for in-hand manipulation, requiring additional tools or systems for tasks like object reorientation. Additionally, many existing solutions lack sufficient sensing and monitoring capabilities, restricting their adaptability to dynamic environments or collaborative tasks.

Some existing gripper technologies provide partial solutions to the limitations mentioned above but fall short of addressing these multifaceted challenges comprehensively. Rigid grippers, while strong and precise, are sometimes unsuitable for fragile or irregularly shaped objects, as they lack compliance. Soft robotic grippers offer compliance but often sacrifice precision, strength, and in-hand manipulation capabilities. Hybrid grippers with variable stiffness attempt to balance rigidity and compliance but are sometimes mechanically complex and often lack integrated sensing or vision systems for dynamic adaptability.

These limitations highlight the need for a versatile and intelligent gripper capable of handling diverse objects, from delicate items to deformable and rigid bags, with precision and safety.

### SUMMARY

In accordance with one aspect of the present disclosure, a robotic arm gripper includes a base unit, a finger module movably disposed on the base unit, and a multi-camera vision system disposed on the base unit. The finger module includes two two-part finger members, each of which includes an inner unit and an outer unit.

In accordance with one aspect of the present disclosure, the inner unit of each of the two-part finger members includes a conveyor mechanism.

In accordance with one aspect of the present disclosure, the conveyor mechanism of the inner unit of each of the two-part finger members includes a conveyor belt, so that when the two-part finger members hold a target object, the conveyor belts are operable to move or rotate the target object along the conveyor belts.

In accordance with one aspect of the present disclosure, the conveyor belts are operable to move in opposite directions to rotate the target object.

In accordance with one aspect of the present disclosure, the inner unit of each of the two-part finger members is made of a rigid material, and the outer unit of each of the two-part finger members is made of an elastic material.

In accordance with one aspect of the present disclosure, the outer unit of each of the two-part finger members includes a deformable tip.

In accordance with one aspect of the present disclosure, the deformable tip of the outer unit of each of the two-part finger members is made of an elastic material.

In accordance with one aspect of the present disclosure, the two-part finger members are laterally movable on the base unit.

In accordance with one aspect of the present disclosure, the multi-camera vision system includes a first camera and a second camera that are disposed on opposite sides of the base unit.

In accordance with one aspect of the present disclosure, wherein the multi-camera vision system includes a palm proximity sensor that is disposed between the two-part finger members.

In accordance with one aspect of the present disclosure, each of the two-part finger members includes a plurality of embedded markers that are embedded in the inner and outer units.

### BRIEF DESCRIPTION OF THE DRAWINGS

Further features and advantages of the present disclosure will become apparent from the following detailed description, taken in combination with the appended drawings, in which:

FIG. 1 schematically illustrates a robotic arm gripper in accordance with some embodiments of this disclosure;

FIGS. 2-1 to 2-4 illustrate various configurations of a multi-camera vision system of the robotic arm gripper;

FIG. 3 illustrates a comparison of a perspective view and a top view of the multi-camera vision system;

FIGS. 4-1 and 4-2 respectively illustrate the maximum and minimum finger translations of two-part finger members of the robotic arm gripper;

FIGS. 5-1 and 5-2 illustrate different variations of deformable tips of each of the two-part finger members;

FIGS. 6-1 to 6-3 illustrate a pinch grasp mechanism of the robotic arm gripper;

FIGS. 7-1 to 7-4 illustrate the robotic arm gripper performing two different tasks;

FIGS. 8-1 to 8-6 illustrate the translation of a target object using a roll-on configuration of the robotic arm gripper;

FIGS. 9-1 to 9-6 illustrate the rotation of a target object using the roll-on configuration of the robotic arm gripper;

FIGS. 10-1 to 10-6 demonstrate complex target object manipulation across various orientations;

FIG. 11 is a perspective view showing the robotic arm gripper being integrated with a robotic manipulator;

FIGS. 12-1 to 12-7 illustrate a placement cycle of the target object using the robotic arm gripper;

FIGS. 13-1 to 13-3 illustrate the robotic arm gripper’s collision with a shelf; and

FIG. 14 illustrates a serious of operation of the robotic arm gripper to transfer a luggage from a conveyor belt to an integrated storage bin.

It will be noted that throughout the appended drawings, like features are identified by like reference numerals.

### DETAILED DESCRIPTION

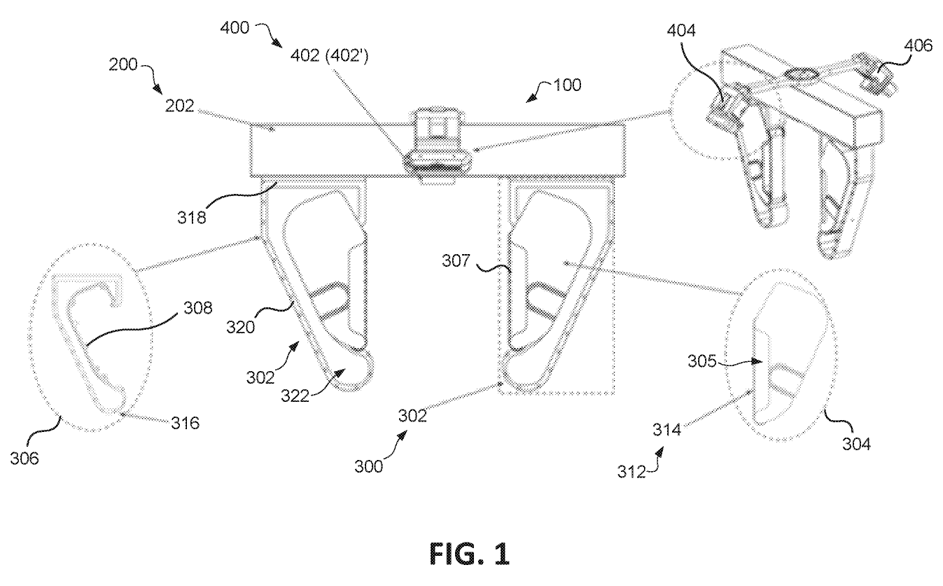

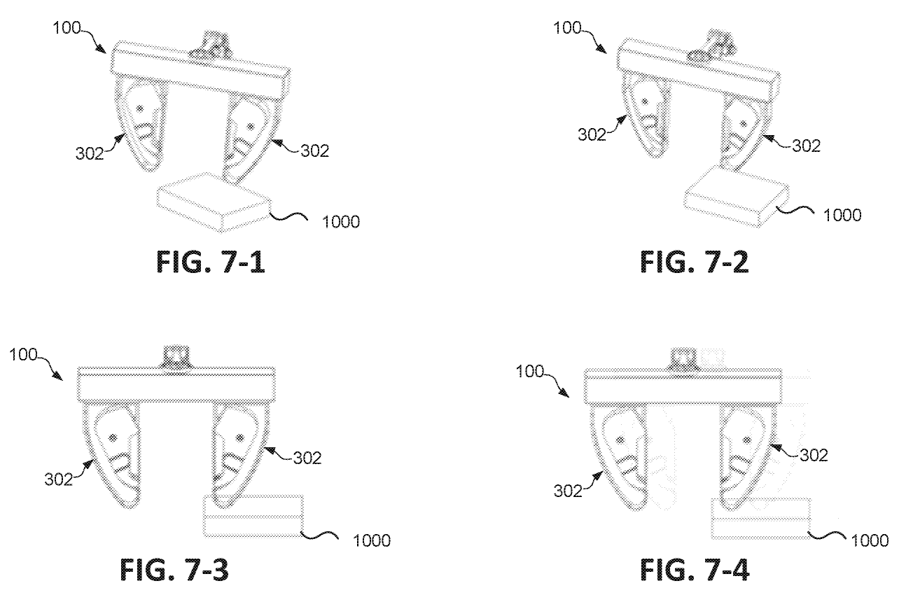

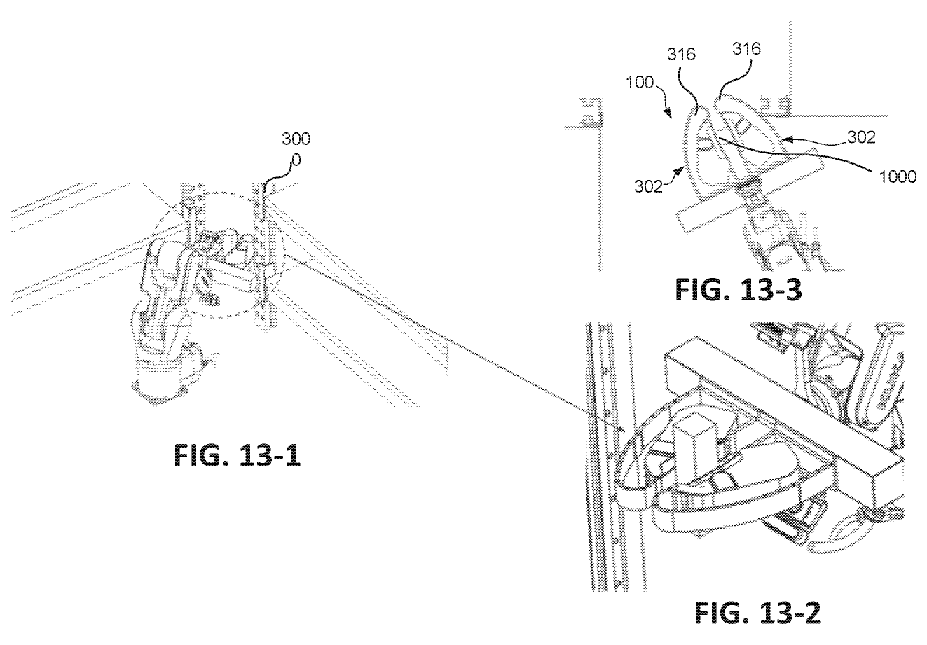

Embodiments are described below, by way of example only, with reference to FIGS. 1-13.

FIG. 1 illustrates an exemplary embodiment of a robotic arm gripper 100 according to the present disclosure, which includes a base unit 200, a finger module 300, and a multi-camera vision system 400.

The base unit 200 supports the finger module 300 and the multi-camera vision system 400 thereon. In some embodiments, the finger module 300 includes two two-part finger members 302 that are movably connected to the base unit 200. As shown in FIG. 1, the two-part finger members 302 may be actuated by a lateral motor unit 202 disposed on the base unit 200 to laterally move on the two-part finger members 302. In some embodiments, the base unit 200 may be formed with lateral grooves (not shown) such that the two-part finger members 302 are actuated to move in the lateral grooves on the base unit 200. Each of the two-part finger members 302 includes an inner unit 304 and an outer unit 306, where the inner unit 304 includes a conveyor mechanism 312 and the outer unit 306 includes a deformable tip 316. In some embodiments, the body of the inner unit 304 may be made of a suitable material, such as metal, plastic, etc., and the dimension of the body varies according to practical requirements. A portion of the body of the inner unit 304 may receive internal components (not shown) of the inner unit, such as motors, sensors, etc. In some embodiments, the conveyor mechanism 312 includes a conveyor belt 314 for manipulating (e.g., conveying, moving, or rotating) objects thereon, and the stiffness of the conveyor belt 314 can be changed for adaptive object handling and in-hand manipulation. The handling of the object will be described in detail hereinafter. The adjustment of stiffness also prevents damage to the target object. In some embodiments, the stiffness of the conveyor belt 314 may be adjusted by changing the tension applied on the conveyor belt 314 by the inner unit within the inner unit 304. In some embodiments, an inner space 305 is provided, allowing the conveyor belt 314 to be deformable relative to the inner space 305, thereby achieving certain degree of compliance while handling an object. In some embodiments, the outer unit 306 includes a first portion 318 and a second portion 320, where the first portion 318 may be made of a suitable rigid material to support the inner unit 304, and the second portion 320 may be made of a suitable deformable material, in which the deformable tip 316 many be part of the second portion 320. In some embodiments, the first and second portions 318, 320 of the outer unit 306 may cooperatively define an outer space 322 therebetween, providing a room for the second portion 320 to be deformed for compliance and conformity purposes. The compliant, deformable tip 316 of each of the two-part finger members 302 facilitates precise pinch grasping, force sensing, and collision absorption. In addition, the deformable tips 316 conform to the target object’s surface, distributing forces evenly to prevent external damage, even during pinch grasping or movement. This reduces the risk of scuffing or breaking fragile contents.

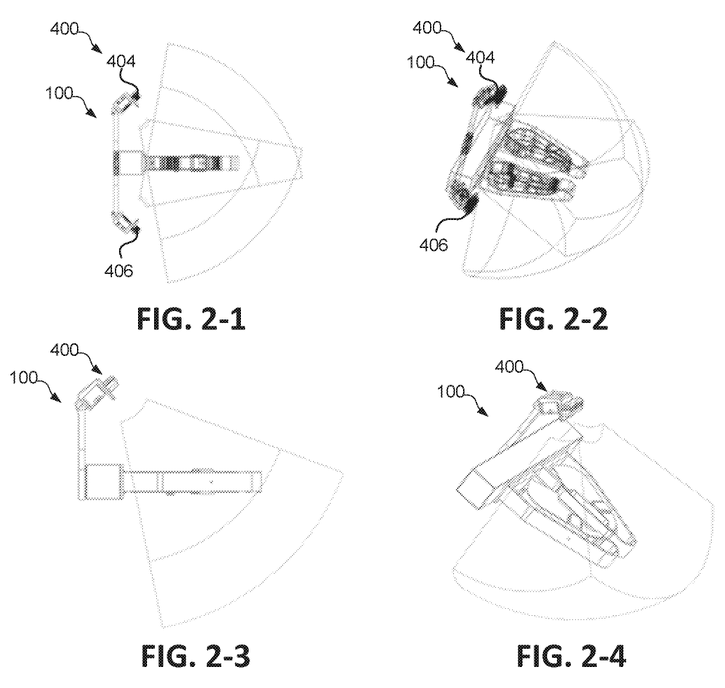

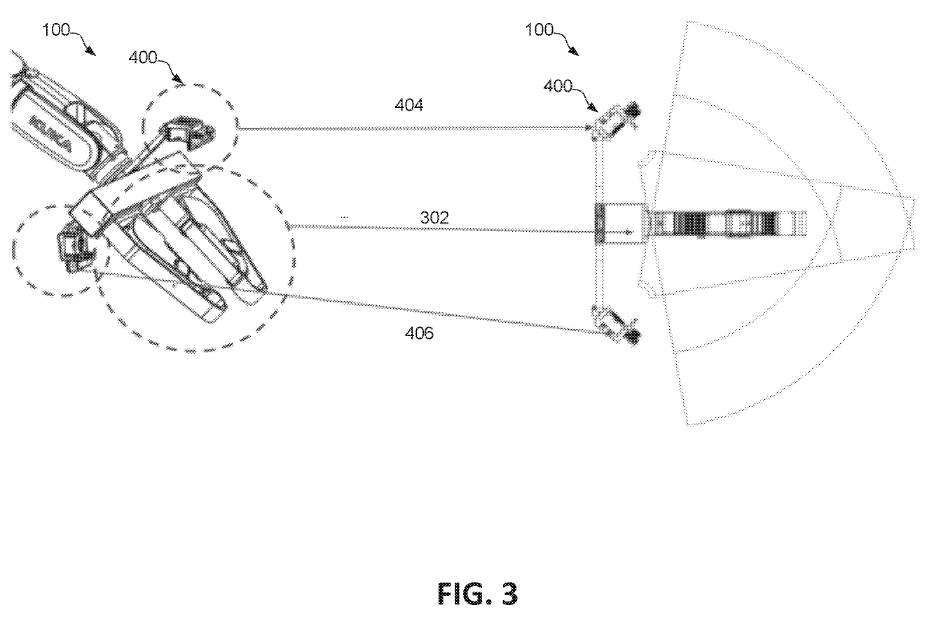

The multi-camera vision system 400 includes a first camera 404 and a second camera 406 that may be disposed at opposite sides of the base unit 200 for observing object features, finger positions (i.e., positions of the two-part finger members 302), and workspace dynamics. The multi-camera vision system 400 may further include a palm camera 402 and/or a palm proximity sensor 402’ that is disposed between the two-part finger members 302 for close-proximity monitoring. FIGS. 2-1 and 2-2 illustrate a two-camera setup with top and 3D views, where the first and second cameras 404, 406 provide wider coverage through overlapping fields of view (FOVs). FIGS. 2-3 and 2-4 illustrate a single-camera setup (i.e., the multi-camera vision system 400 includes only one of the first and second cameras) with top and 3D views. FIG. 3 is a comparison of a perspective view and a top view of the multi-camera vision system 400.

As illustrated by FIG. 1, in some embodiments, the inner and outer units 304, 306 may be provided with multiple embedded markers (including embedded inner markers 307 on the inner units 304 and embedded outer markers 308 on the outer units 306) and embedded sensors (might be located in the inner unit 304 and/or the outer unit 306) for exteroceptive feedback (e.g., object orientation and deformation) and proprioceptive feedback (e.g., force of the two-part finger members applied to the object). In some embodiments, the embedded markers (including the embedded inner markers 307 and the embedded outer markers 308) provide kinesthetic and displacement information related to the finger module’s 300 interaction with target objects. The first and second cameras 404, 406 of the multi-camera vision system 400 may be configured to capture interaction data through observation, for example, by tracking the embedded markers to extract various features for precise handling of the target objects.

The multi-camera vision system 400 observe the target object, the finger module 300, and the workspace, enabling precise object tracking, pose estimation, and collision detection.

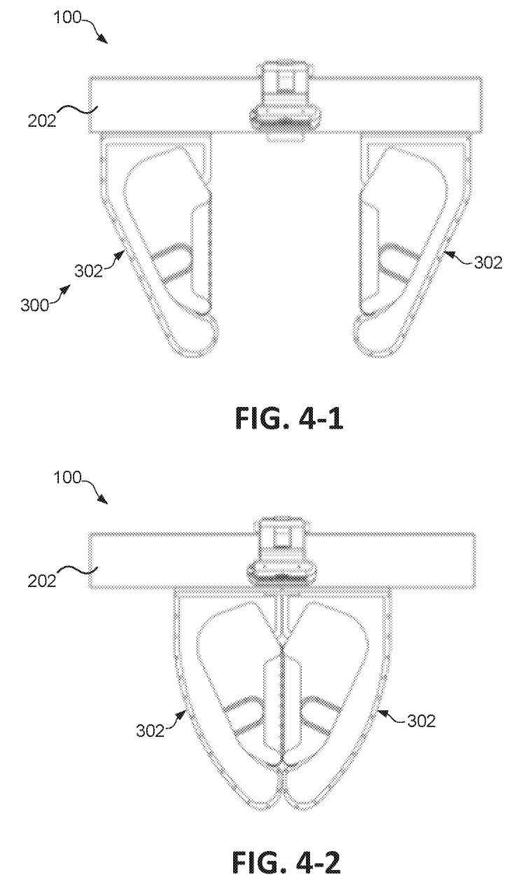

FIGS. 4-1 and 4-2 illustrate the maximum and minimum finger translations (i.e., translations of the two-part finger members 302 of the finger module 300) controlled by the lateral motor unit 202. FIG. 4-1 shows that the two-part finger members 302 are moved to the maximum finger translation position (i.e., fingers fully open), and FIG. 4-2 shows that the two-part finger members 302 are moved to the minimum finger translations (i.e., fingers closed).

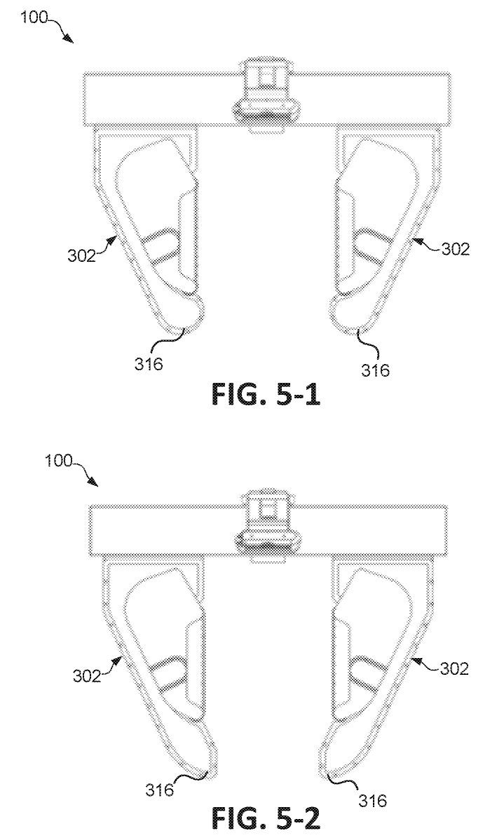

FIGS. 5-1 and 5-2 illustrate different variations of the deformable tip 316 of each of the two-part finger members 302, where in FIG. 5-1, the deformable tips 316 are rounded in shape, and in FIG. 5-2, the deformable tips are shaper in shape. By using deformable tips with a suitable shape, the robotic arm gripper 100 can be adopted to different environments and to interact with different target objects.

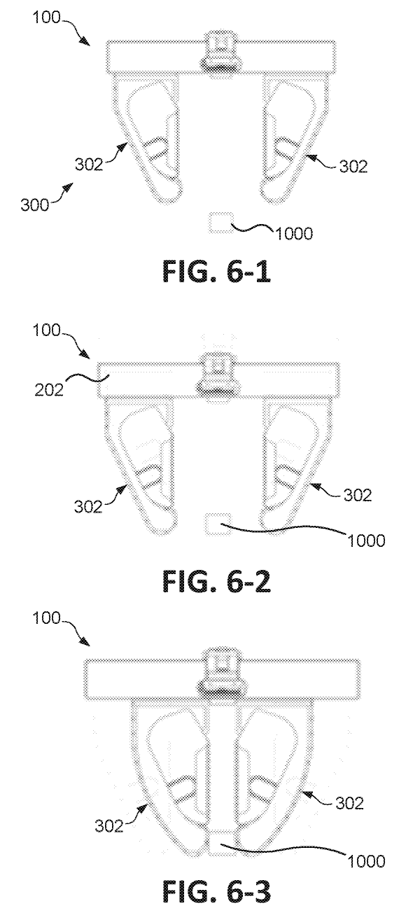

FIGS. 6-1 to 6-3 illustrate a pinch grasp mechanism of the robotic arm gripper 100. In FIG. 6-1, the two-part finger members 302 of the finger module 300 approach and align with a target object 1000 for precise positioning. In FIG. 6-2, the lateral motor unit 202 engages and drives the two-part finger members 302 to move inwardly towards the target object 1000. In FIG. 6-3, the two-part finger members 302 establish contact with the target object 1000, executing a pinch grasp to securely hold the target object 1000 for manipulation or transport.

FIGS. 7-1 to 7-4 illustrate the robotic arm gripper 100 performing two different tasks. In FIGS. 7-1 and 7-2, at least one of the two-part finger members 302 may be actuated to push the target object 1000, causing the target object 1000 to move and/or rotate. FIGS. 7-3 and 7-4 are top views showing at least one of the two-part finger members 302 may be actuated to push the target object 1000 to move and/or rotate.

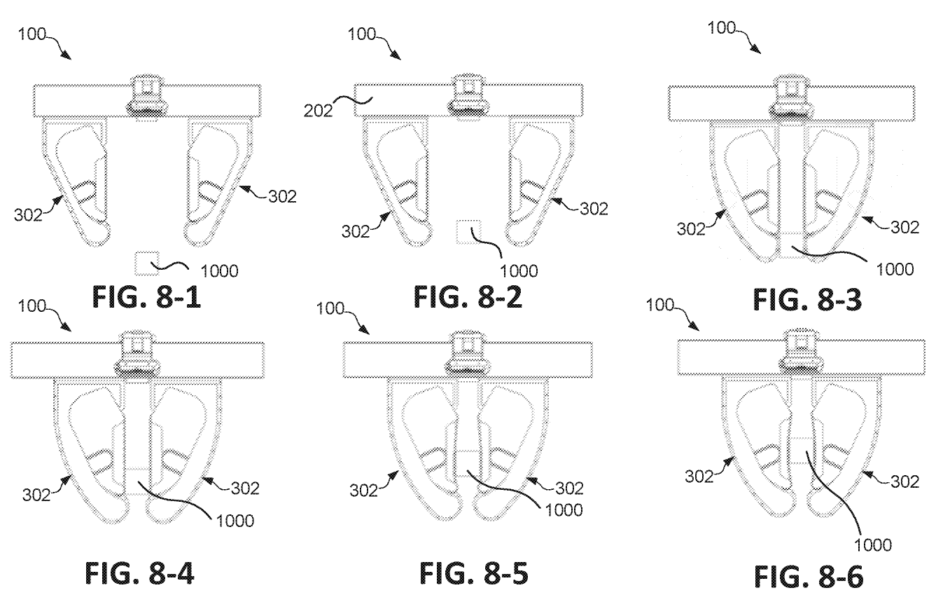

FIGS. 8-1 to 8-6 illustrate the translation of the target object 1000 using a roll-on configuration of the robotic arm gripper 100, where the sequence demonstrates the gradual movement of the two-part finger members 302 as they roll and adjust to grip the target object 1000. Such operation allows the target object to translate smoothly, maintaining contact with the two-part finger members throughout the process to ensure a secure grasp and controlled motion during manipulation. Specifically, in FIG. 8-1, the robotic arm gripper 100 is operated to align with the target object 1000. In FIG. 8-2, the robotic arm gripper 100 is moved toward the target object 1000. If the two-part finger members 302 are too close to each other to accommodate the target object 1000, the lateral motor unit 202 may be operated to move the two-part finger members 302 further away from each other. In FIG. 8-3, the two-part finger members 302 are operated to grip the target object 1000. The robotic arm gripper 100 may then be operated to move the target object 1000 to a desired location. Referring to FIGS. 8-4 to 8-6 with reference to FIG. 1, the conveyor belts 314 of the conveyor mechanisms 312 may be operated to move the target object 1000 while the two-part finger members 302 is gripping the target object 1000, achieving an “in-hand” movement of the target object 1000.

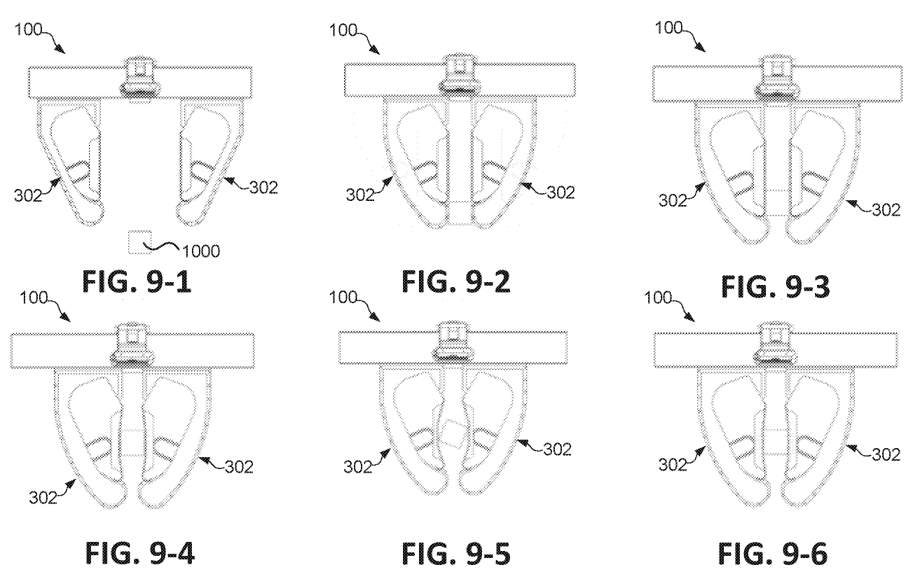

FIGS. 9-1 to 9-6 illustrate the rotation of the target object 1000 using the roll-on configuration of the robotic arm gripper 100. In FIG. 9-1, the two-part finger members 302 start in an open position, aligning themselves ready to engage with the target object 1000. In FIG. 9-2, the two-part finger members 302 begin to close, making initial contact with the target object 1000. In FIG. 9-3, the target object 1000 is securely grasped by the two-part finger members 302, and the rotation process starts. In FIG. 9-4, the two-part finger members 302 adjust, gradually rolling the target object 1000 between them to initiate rotational movement. FIG. 9-5, further rotation of the target object 1000 occurs as the two-part finger members 302 continue their coordinated motion, repositioning the target object 1000. In FIG. 9-6, the target object 1000 completes its rotation, with the two-part finger members 302 maintaining a stable grip throughout the process. Referring further to FIG. 1, in some embodiments, the rotation of the target object 1000 may be achieved by moving the conveyor belts 314 of the conveyor mechanisms 312 in opposite directions.

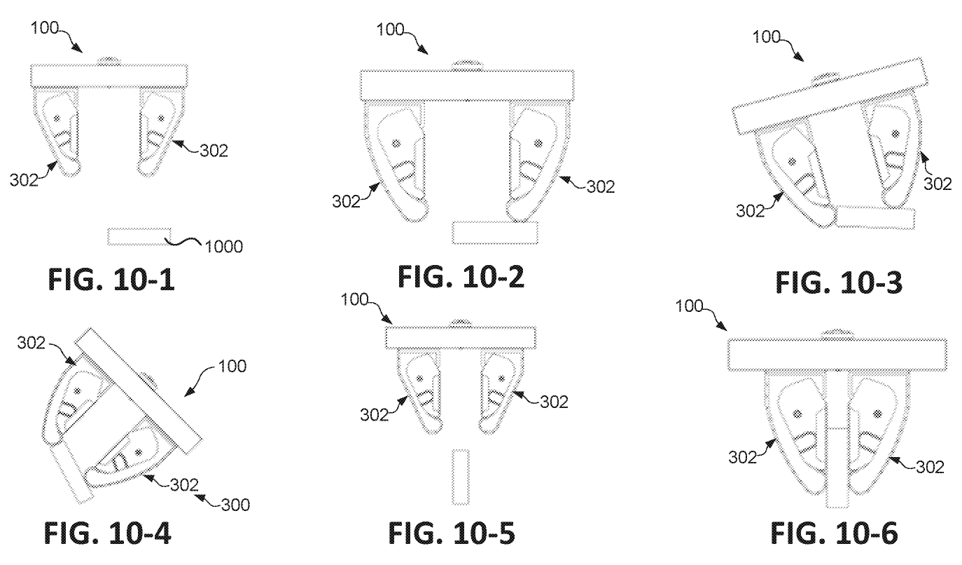

FIGS. 10-1 to 10-6 demonstrate complex target object manipulation across various orientations. In FIG. 10-1, the target object 1000 is presented in a horizontal position, and the two-part finger members 302 prepare to engage. FIG. 10-2, the two-part finger members 302 begin to close on the target object 1000, maintaining stability. In FIG. 10-3, the target object 1000 is rotated to an inclined angle while still being firmly grasped by the two-part finger members 302. In FIG. 10-4, the finger module 300 further adjust the target object’s orientation, shifting the target object to a near-vertical angle. In FIG. 10-5, the target object is rotated vertically, showing the finger module’s ability to manipulate the target object to an upright position. In FIG. 10-6, the target object is held vertically by the two-part finger members 302 in a stable position, demonstrating the final phase of orientation control.

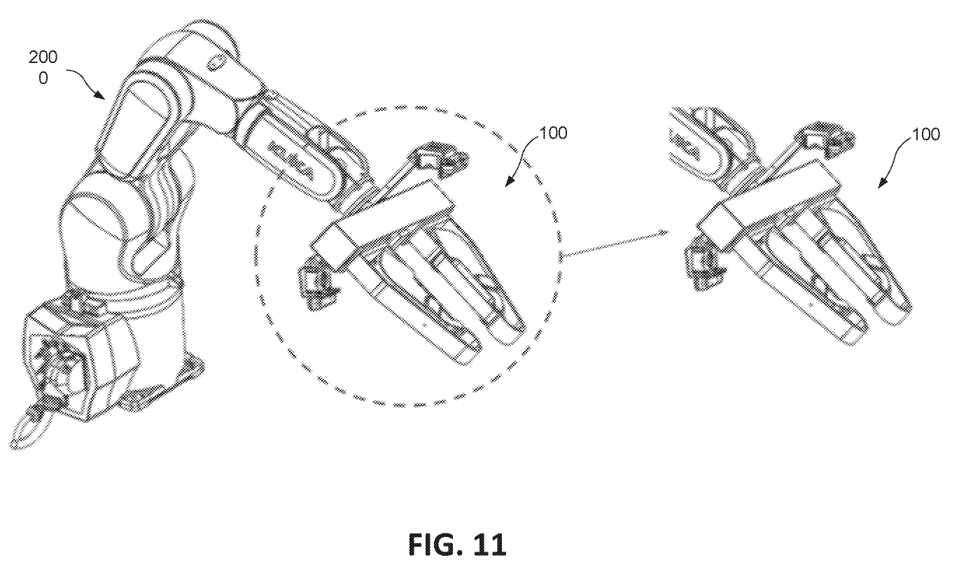

FIG. 11 is a perspective view showing the robotic arm gripper 100 being integrated with a robotic manipulator 2000.

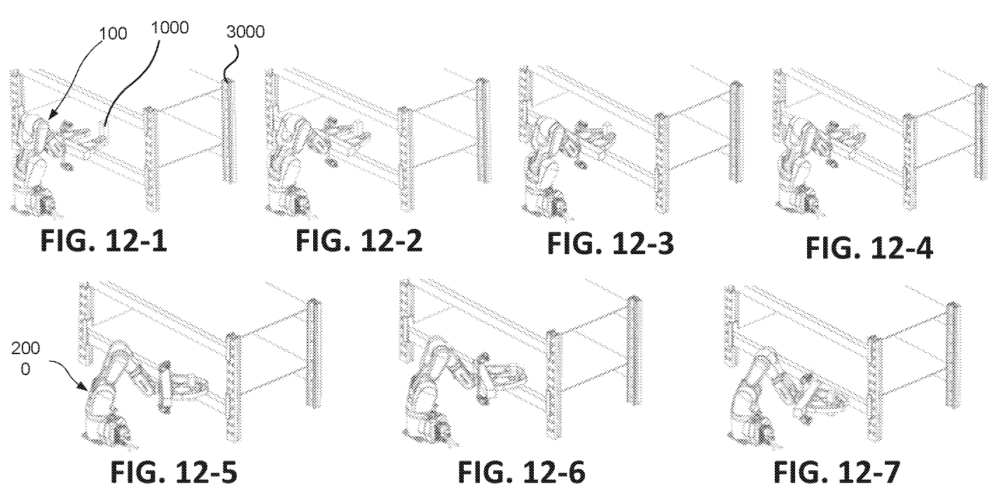

FIGS. 12-1 to 12-7 illustrate a placement cycle of the target object 1000 using the robotic arm gripper 100 in, for example, a warehouse environment. The sequence shows the robotic arm gripper 100 approaching, aligning, placing, and withdrawing after positioning the target object onto a storage rack. This demonstrates the step-by-step process of automated object handling in warehouse operations. Similar to FIGS. 6-1 to 6-3 with reference to FIG. 1, the robotic arm gripper 100 first approaches and aligned with the target object 1000 placed on a shelf 3000 (see FIG. 12-1). In FIG. 12-2, the two-part finger members 302 are moved to two sides of the target object 1000. In FIG. 12-3, the two-part finger members 302 are actuated to hold the target object 1000. In FIGS. 12-4, the conveyor belts 314 of the conveyor mechanisms 312 are actuated to move the target object 1000 toward the base unit 200, so that the two-part finger members 302 may more securely hold the target object 1000. In FIGS. 12-5 to 12-7, the robotic manipulator 2000 rotates so that the robotic arm gripper 100 carries the target object 1000 to move away from the shelf 3000.

FIGS. 13-1 to 13-3 illustrate that the robotic arm gripper 100 collides with the shelf 3000. Each of the two-part finger members 302, including the deformable tip 316 of the outer unit 306 may be made of an elastic material to elastically deform upon impact, preventing damages to both the finger module 300 and the target object 1000 held thereon. FIGS. 13-1 to 13-3 demonstrate the robotic arm gripper’s 100 ability to handle accidental collisions without compromising the integrity of the robotic arm gripper 100 and the target object 1000. In some embodiments, bodies of the inner and outer units 304, 306 of each of the two-part finger members 302 may be made of an elastic material to achieve the damage prevention purposes.

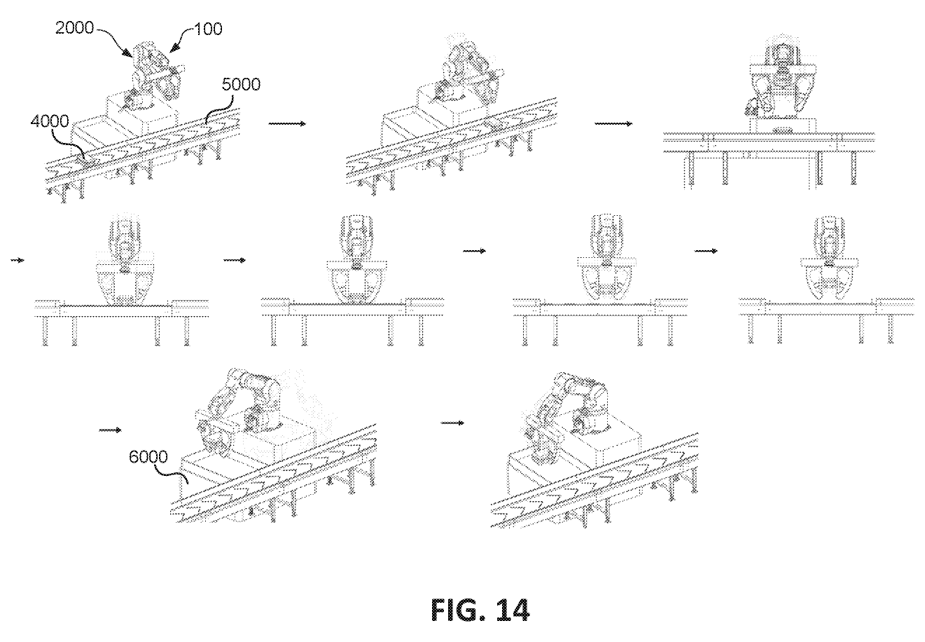

FIG. 14 illustrates that the robotic arm gripper is operated for a luggage-handling process. A piece of luggage 4000 arrives on a conveyor belt 5000 and halts at a designated pick-up location. The robotic manipulator 2000 aligns its robotic arm gripper 100 to achieve a graspable position, lowers to touch the conveyor belt 5000, and uses a roll-on motion to secure the luggage 4000 by translating it to the middle of the two-part finger members 302 through the conveyor mechanisms 312. Once secured, the mobile manipulator transports the luggage to its integrated storage bin 6000 and places it inside. Such configuration ensures fast, efficient, and damage-free handling of luggage while ensuring safety with the environment.

The robotic arm gripper of the present disclosure introduces several features. Each of the two-part finger members combines the inner unit with a roll-on mechanism (i.e., the conveyor mechanism) for precise target object translation, reorientation, and manipulation, and the outer unit that provides compliance and safe deformation for adaptive and damage-free grasping (i.e., collision safety). The two-part finger members also collectively provide functionality of in-hand manipulation. Such combination of the inner and outer units makes the robotic arm gripper suitable for various applications, such as cargo and luggage handling, where protecting both the external surface and internal contents of items is critical. The integration of the multi-camera vision system enables a comprehensive view of the target object, finger module, and workspace, facilitating precise handling in real-time. The multi-camera vision system further enables exteroceptive detection (e.g., features of the target object), proprioceptive detection (e.g., force applied to the target object, and positions of the target object and the finger module), ensuring safe and efficient operation, workspace monitoring, and precise feedback. With the collision-tolerant design, the finger module (e.g., the outer units) absorbs impacts without damage, making it suitable for collaborative robotic applications, such as integration with fixed or mobile manipulators. By supporting pinch grasping, object translation, and reorientation within a single system, the robotic arm gripper enhances efficiency and usability across diverse tasks, including industrial automation, logistics, and warehouse operations.

The robotic arm gripper can be customized and leveraged to create various commercial products and services across various industries, offering enhanced capabilities and safety for handling diverse objects in dynamic environments. The robotic arm gripper may be applied to various areas, including warehouse automation and logistics (enhancing efficiency by automating tasks such as picking, sorting, and packing to be seamlessly integrated with mobile robots in dynamic environment), retail and e-commerce, healthcare and pharmaceuticals, consumer robotics, agriculture and food processing, logistics and supply chain, research and development, space exploration, etc. The robotic arm gripper may also be applied to manufacturing, where the robotic arm gripper enables precision assembly of diverse components, including fragile and irregular parts, ensuring adaptability and reliability. When applied to the food industry, the robotic arm gripper offers the ability to safely handle soft or deformable items during packaging and processing. In terms of agriculture applications, the robotic arm gripper provides gentle harvesting and sorting of delicate produce, minimizing damage to the produce. Moreover, the robotic arm gripper’s compliance and safety make it ideal for collaborative robotics, where it enhances adaptability and ensures safe interaction in human-robot workspaces.

In other applications, the robotic arm gripper may be applied to address critical challenges in cargo and luggage handling by introducing a compliant gripper system capable of safely managing irregular, deformable and rigid bags. The inner unit of each of the two-part finger members, equipped with the roll-on conveyor mechanism, adapts to varied shapes and sizes of objects, enabling precise reorientation and manipulation with adjustable force. The outer unit of each of the two-part finger members ensures safe, compliant deformation, protecting both the external surface and contents of luggage from damage. The integrated multi-camera vision system enhances object detection and monitoring, while the robotic arm gripper’s collision tolerance ensures reliability in dynamic environments. Therefore, the robotic arm gripper may be appliable for automated cargo sorting, inspection, and transport, seamlessly integrating with robotic system for efficient and damage-free operations.

The robotic arm gripper of this disclosure possesses several capabilities, including adaptability, precision, in-hand manipulation, safety, and integration. In terms of adaptability, the robotic arm gripper handles target objects of varying shapes and sizes with compliance and precision. In terms of precision, multi-camera and sensing integration enables accurate object detection and manipulation and comprehensive monitoring of embodiment and workspace. In terms of in-hand manipulation, reorientation of the target objects using the roll-on conveyor unit (i.e., the conveyor mechanism) for advanced handling tasks can be achieved. In terms of safety, the compliance design ensures damage-free handling of delicate objects and tolerance to collisions. In terms of integration, the robotic arm gripper is easily compatible with robotic automation system, fixed manipulators, and mobile robots for dynamic environments.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms "comprises" and "comprising" and variations thereof mean that the specified features, steps, or components are included. The terms are not to be interpreted to exclude the presence of other features, steps, or components.

The invention may also broadly consist in the parts, elements, steps, examples and/or features referred to or indicated in the specification individually or collectively in any and all combinations of two or more said parts, elements, steps, examples, and/or features. In particular, one or more features in any of the embodiments described herein may be combined with one or more features from any other embodiment(s) described herein.

1. A robotic arm gripper comprising:
a base unit;
a finger module movably disposed on the base unit; and
a multi-camera vision system disposed on the base unit,
wherein the finger module includes two two-part finger members, each of which includes an inner unit and an outer unit.

2. The robotic arm gripper of claim 1, wherein the inner unit of each of the two-part finger members includes a conveyor mechanism.

3. The robotic arm gripper of claim 2, wherein the conveyor mechanism of the inner unit of each of the two-part finger members includes a conveyor belt, so that when the two-part finger members hold a target object, the conveyor belts are operable to move or rotate the target object along the conveyor belts.

4. The robotic arm gripper of claim 3, wherein the conveyor belts are operable to move in opposite directions to rotate the target object.

5. The robotic arm gripper of claim 1, wherein the inner unit of each of the two-part finger members is made of a rigid material, and the outer unit of each of the two-part finger members is made of an elastic material.

6. The robotic arm gripper of claim 1, wherein the outer unit of each of the two-part finger members includes a deformable tip.

7. The robotic arm gripper of claim 6, wherein the deformable tip of the outer unit of each of the two-part finger members is made of an elastic material.

8. The robotic arm gripper of claim 1, wherein the two-part finger members are laterally movable on the base unit.

9. The robotic arm gripper of claim 1, wherein the multi-camera vision system includes a first camera and a second camera that are disposed on opposite sides of the base unit.

10. The robotic arm gripper of claim 1, wherein the multi-camera vision system includes a palm proximity sensor that is disposed between the two-part finger members.

11. The robotic arm gripper of claim 1, wherein each of the two-part finger members includes a plurality of embedded markers that are embedded in the inner and outer units.
